(19) United States
(12) Patent Application Publication
(10) Pub. No.: US 2006/0254431 A1
(43) Pub. Date: Nov. 16, 2006

(54) Container with telescoping handle

(75) Inventors: Dino A. Mariano, Pittsburgh, PA (US); Eric Richard Colburn, Wexford, PA (US); Keith DeLawrence Brown, Montclair, NJ (US)

Correspondence Address: SEYFARTH SHAW LLP, 131 S. DEARBORN ST., SUITE2400, CHICAGO, IL, 60603-5803, US

(73) Assignee: Helen of Troy Limited

(21) Appl. No.: 11/347,778

(22) Filed: Feb. 3, 2006

Related U.S. Application Data
(63) Continuation-in-part of application No. 11/128,833, filed on May 13, 2005.

(51) Int. Cl. A47J 37/12

(52) U.S. Cl. 99/415

(57) ABSTRACT

A container includes a platform supported by legs and a handle extending from the platform and including a base for attaching the handle to the platform. The handle includes a first telescoping section nested within a second telescoping section, a grip attached to the second telescoping section, a rod extending from the grip and a latching member attached to the base for engaging the rod when the handle is in a compressed condition. The legs may be pivotally attached to the platform and each leg may be formed of wire having a generally rectangular shape with a first side and a second side. The platform may be formed of interleaved portions pivotally attached to a central hub and each section may be movable between an open and closed position. The handle may be biased in order to extend the handle when the latch member is released from the rod. The container may be disposed in an enclosure having a lid and the handle may abut the lid and removal of the lid activates the latching member to bias the rod and allow the handle to extend out of the enclosure.

This application is a continuation-in-part of co-pending application Ser. No. 11/128,833 filed May 13, 2005, which is incorporated herein by reference.

The present invention pertains to a container for holding food items on a platform and a telescoping handle having a track and a latching member.

### BACKGROUND

Containers for holding food items in order to assist in the cooking of the food are known, such as steamers which have metal platforms and folding leaves. Most known steamers have a central hub and the foldable leaves extend from the hub and pivot between an open and closed position. The hub and leaves provide the platform. In the open position, the platform can hold food items, such as vegetables for steaming in a pot. The hub also has a central rod protruding upward. The rod may be grabbed by a user's hand in order to place the steamer into and remove it from a pot. In most current steamers, the rod is a non-movable member which is securely fastened to the steamer hub. The rod is generally no longer than the height of a standard pot. In this way, when the lid of the pot is placed on the pot during cooking, the rod will not interfere and the lid may be placed down securely onto the pot so that steam may be sealed and maintained within the pot for maximum cooking of food items. However, due to the length of the rod—which does not extend above the pot after removal of the lid—a user may burn his fingers because he has to reach down into the steam filled pot in order to remove the steamer. This is a dangerous situation which can cause severe burns to a user's fingers when he is attempting to grab the rod and remove the steamer. There is desired a steamer having a handle which can extend up and out of the pot, so that the steamer may be easily lifted out of the pot, without requiring the user to submerse his or her fingers down into the steam filled pot in order to grab and remove the steamer.

Thus, there is desired a handle having a latching mechanism which can automatically extend the handle and lock it in a compressed condition that may be used, in an embodiment, for a steamer. Known latching mechanisms for other devices generally require too many moving parts and are expensive to assemble and manufacture and do not allow the handle to extend sufficiently. For example, such latching mechanisms are known that include a track and a latch member that rides in a track; however, the finger must be maintained in the track during all conditions. Such known mechanisms do not allow for the finger to be disposed from the track to allow for extra extension of the latching mechanism body. Thus, there is desired a latching mechanism and handle which allows for a simple mechanism, having few parts that is fully extendable.

### SUMMARY

The present invention provides for a container comprising a platform supported by legs and a handle extending from the platform and including a base for attaching the handle to the platform, a first telescoping section attached to the base nested within a second telescoping section, a grip attached to the second telescoping section, a rod extending from the grip and a latching member attached to the base for engaging the rod when the handle is in a compressed condition. In an embodiment, the legs may be pivotally attached to the platform. In an embodiment, each leg may be formed of wire having a generally rectangular shape with a first side and a second side. In an embodiment, the first side may be received by a generally U-shaped bracket attached to the platform and the second side of the leg may be bent to provide a support foot. In an embodiment, the platform may be formed of interleaved portions pivotally attached to a central hub and each section may be movable between an open and closed position.

In an embodiment, the rod may include a track for receiving the latching member and the track may have a compression channel through which the latching member advances during compression of the handle and an extension channel through which the latching member advances during extension of the handle. In an embodiment, the latching member may include a finger that rides upward through the compression channel and downward through the extension channel. In an embodiment, the handle may be biased in order to extend the handle when the latching member is released from the rod. In an embodiment, the container may be disposed in an enclosure having a lid and the handle abutting the lid when the handle is in the compressed condition and removal of the lid allows the latching member to ride upward through the compression handle and allow the handle to extend out of the enclosure.

In a further embodiment, the invention provides for a telescoping handle comprising a rod having a track, a first telescoping section extending from the second telescoping section, a base attached to the first telescoping section, a latching member pivotally attached to the base and the second telescoping section surrounding the rod. The handle having a compressed condition and an extended condition and the latching member received in the track and engaging the rod in the compressed condition and the latching member disposed from the track in the extended condition.

In an embodiment, the latching member may include a finger that rides in the track and engages a notch formed within the track so that the handle is locked in the compressed condition. In an embodiment, the handle may include a bias member for biasing the handle to the extended condition when the finger is released from the notch. In an embodiment, the track may include a release feature that directs the finger away from the notch toward an extension channel so that the handle is provided in the extended condition.

In an embodiment, the track may comprise a longitudinal axis and pressing on the handle imparts a compression force along the longitudinal axis and the compression force may cause the finger to engage the release feature so that the handle is biased to the extended condition. In an embodiment, the track may include a lock feature that directs the finger toward the notch so that the finger engages the notch in order to lock the handle in the compressed condition. In an embodiment, the finger may have a first control surface and a second control surface and the track may have a compression channel, an extension channel, a release feature and a first off-set feature so that upon moving the finger through the track the first control surface engages the first off-set feature to move the finger into the compression channel and the second control surface engages the release feature to move the finger into the compression channel and the second control surface engages the release feature to move the finger into the extension channel. In an embodiment, the finger may include a latch surface for engaging the notch of the track after the finger is directed by a lock feature of the track. In an embodiment, a generally V-shaped notch may be formed in the track and the latch surface may be generally V-shaped to engage the notch in order to lock the handle in the compressed condition.

A further embodiment of the invention provides for a method for controlling compression and extension of a handle comprising the steps of providing a handle including a first and second telescoping section having a base and a latching member attached to the base and a track disposed within the first telescoping section, compressing the handle with a first actuation force, advancing the latching member through the track and nesting the first telescoping section at least partially within the second telescoping section, locking the latching member within the track in a locked position to lock the handle in a compressed condition, compressing the handle with a second actuation force, releasing the latching member from the locked position and advancing the latching member through the tracks so that the base is extended beyond the second telescoping section and the latching member is extended beyond the track.

In an embodiment, the track may include off-set features to cause the latching member to reciprocate within the track in order to move in and out of the locked position. In an embodiment, the track may include a longitudinal axis and the latching member may reciprocate perpendicular to the longitudinal axis. In an embodiment, the track may include an extension channel and a compression channel and the method may further comprise the steps of advancing the latching member through the extension channel causing the handle to extend and advancing the latching member through the compression channel causing the handle to compress.

In an embodiment, the second telescoping section may include a grip end and an opposite exposed end and the first telescoping section includes a nested end and an opposite uncovered end and the latching member may be extended beyond the exposed end of the second telescoping section when the handle is in an extended condition and a majority of the first telescoping section is extended at least partially beyond the exposed end of the second telescoping section. In an embodiment, the handle may include a third telescoping section having a covered end nested within the uncovered end of the second telescoping section and a base having the latching member and in the extended condition the base extends beyond the uncovered end. In an embodiment, the handle may include a profiled notch in the track corresponding to the shape of the latching member and the track including a release feature and the method further comprising the step of automatically advancing the latching member from the locked position to an unlocked and extended condition of the handle due to the latching member being directed out of the profiled notch toward the release feature that advances the latching finger to the extension channel.

In an embodiment, the handle may include a first off-set feature and a lock feature in the track, the method further comprising the step of automatically advancing the latching member from the unlocked position to the locked position due to the latching member being directed by the first off-set feature into the compression channel that advances the latching finger against the lock feature and into the notch in order to obtain the locked position. In an embodiment, the latching member may be freely pivotable between a locked and unlocked position and is advanced only by off-set features provided by the track. In an embodiment, the handle may include only one bias member acting to bias the first telescoping section away from the second telescoping section.

In another embodiment, the present invention provides for a latching mechanism comprising a body including a stop abutment and a track having a first off-set feature, a notch, a latching member extending from a base, the latching member including a first control surface and a latch surface, the latching member rides in the track between a locked position and an unlocked position wherein the first control surface engages the first off-set feature directing the latch surface to engage the notch to obtain the locked position and a bias member biasing the notch and the latch surface together in order to lock the latching mechanism in the locked position and biasing the latching member and body apart until the stop abutment is engaged in order to position the latching member in the unlocked position.

In an embodiment, the body may include a first recess for receiving a first end of the bias member and the first recess generally adjacent the notch, the body may also include a second recess for receiving a second end of the bias member and the second recess may be generally adjacent the base so that the latch member may be positioned alongside the bias member during its compression and expansion. In an embodiment, the channel is formed in a rod attached to a first telescoping section and the bias member at least partially surrounds the rod. In an embodiment, the body may further comprise a first telescoping section and a second telescoping section and the stop abutment disposed on the first telescoping section and a flange protruding from the second telescoping section and wherein the bias member extends between the track and the base and the bias member biasing the track upward away from the latching member until the flange engages the stop abutment.

A further embodiment of the invention, provides for an indexing apparatus comprising a rod having a guide track, a finger disposed in the track and the finger having a first control surface and a second control surface, a bias member causing the finger to travel and reciprocate within the track, travel to an extended position beyond the track, positioning features working in combination with the finger and the bias member engaging the first and second control surfaces in order to control the position of the finger and lock the finger in a locked position.

In an embodiment, the rod may extend from a grip and the indexing apparatus may provide a locking mechanism for a handle. In an embodiment, the finger may protrude from a latching member pivotally mounted to a base disposed adjacent the track. In an embodiment, the finger may have a generally hexagonally shaped cross-section. In an embodiment, the bias member may cause the finger to reciprocate along a longitudinal axis of the track. In an embodiment, the position features include an off-set feature and a lock feature provide by an inner wall of the track in order to cause the finger to reciprocate within the track and generally perpendicular to a longitudinal axis of the track. In an embodiment, the track may include a compression channel and an extension channel and the finger travels in the compression channel to move the finger away from the extended position and in the extension channel to move the finger towards the extended position.

### BRIEF DESCRIPTION OF THE DRAWINGS

For the purpose of facilitating an understanding of subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of the container of the present invention in the open position;

FIG. 2A is an exploded perspective view of the latching mechanism of the handle of the container of FIG. 1;

FIG. 2B is a exploded perspective view of the telescoping sections of the handle of FIG. 1;

FIG. 3 is a sectional view taken at line 3-3 of FIG. 1;

FIG. 4 is a sectional view similar to FIG. 3 in the compressed condition;

FIG. 5 is a plan view of the handle of FIG. 1;

FIG. 6 is a sectional view taken at line 6-6 of FIG. 5 in the compressed condition;

FIG. 7 is a sectional view similar to FIG. 6 in the extended condition; and

FIG. 8 is an enlarged view of the latching mechanism of FIG. 4 with a diagrammatic representation of the latching member depicted in multiple positions.

### DETAILED DESCRIPTION

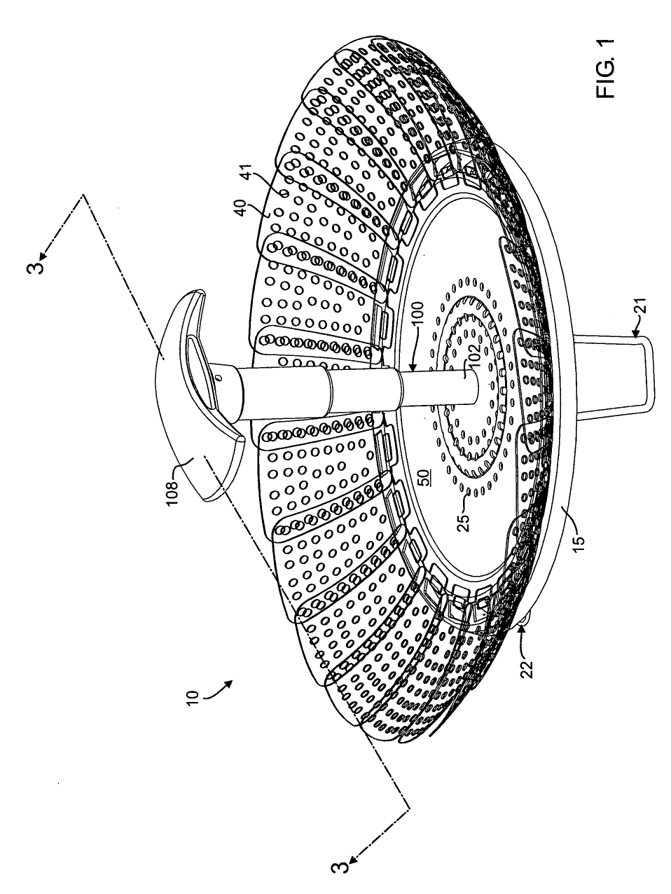

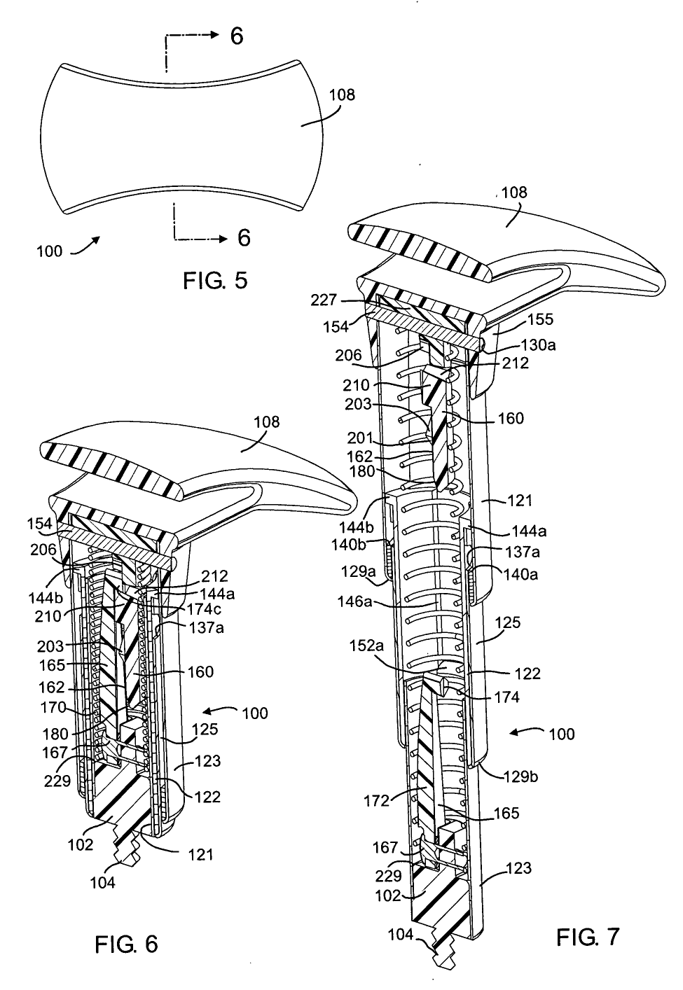

An embodiment of the present invention is depicted with respect to FIGS. 1-8. A container 10 is provided including a platform 15, supported by legs 21, 22, 23. In an embodiment, the platform 15 is metal and may hold food items such as vegetables. The platform 15 includes apertures 25 formed therein. In an embodiment, the container 10 may be used for steaming vegetables and the apertures 25 allow for steam to penetrate the platform 15 in order to cook the vegetables placed thereon.

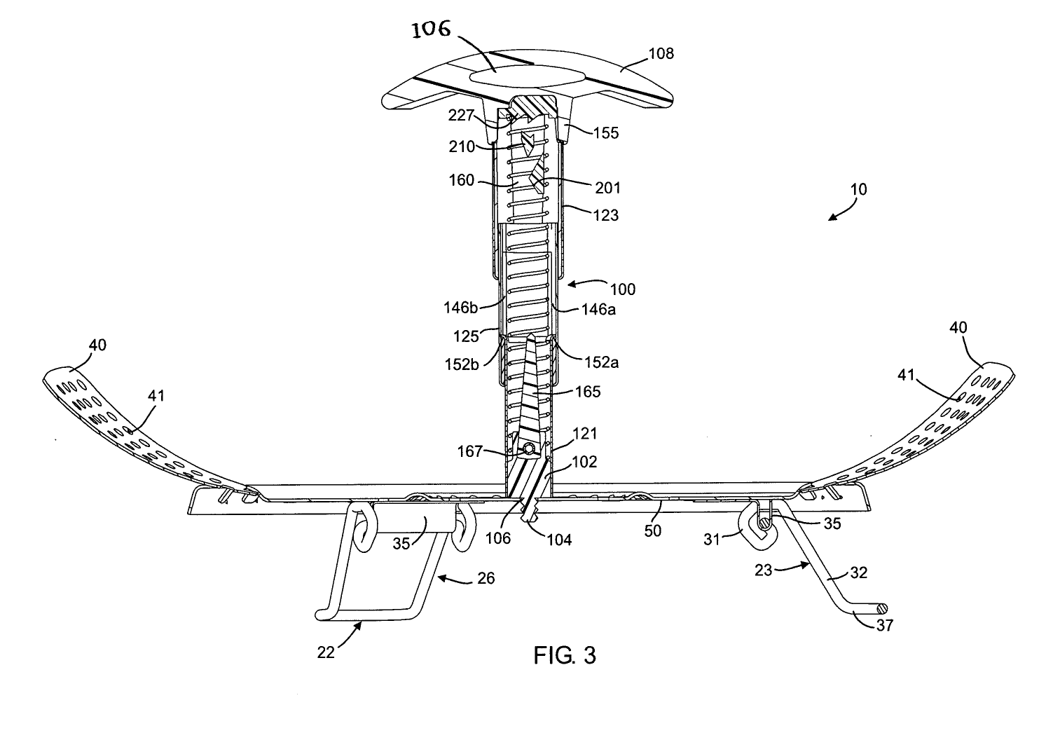

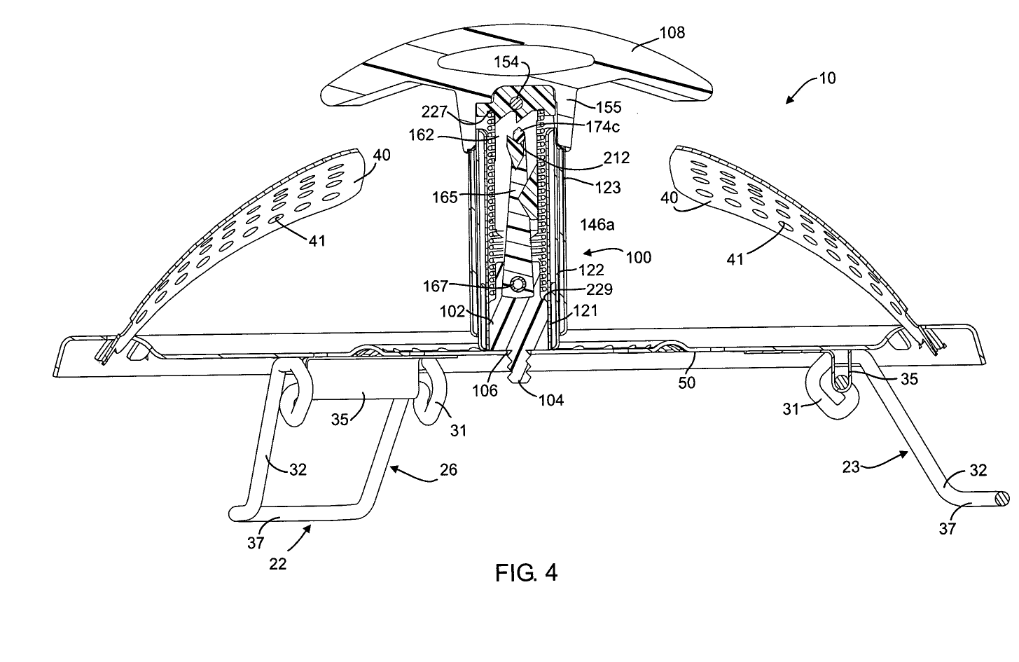

In an embodiment, the container includes three legs 21, 22, 23. In an embodiment, more legs may be provided in order to provide additional stability for the platform 15. In an embodiment, each leg is generally formed of a rectangular shape formed by a wire 26. Each leg has a first side 31 and a second side 32 (FIGS. 3 and 4). In an embodiment, the first side 31 is received by a U-shaped bracket 35. The bracket 35 is attached to the bottom of the platform 15. In an embodiment, the bracket 35 may be metallic and may be welded to the platform 15. The second side 32 of each leg 21, 22, 23 is bent and forms a support foot 37 that is bent generally parallel to the platform 15 so that it may be supported and kept level when the container 10 is disposed within an enclosure, such as a cooking pot. Each leg 21, 22, 23 is pivotally attached to the platform 15 via the brackets 35 so that they may be moved from the extended position, as shown in FIGS. 1, 3, 4, to a closed position folded against the bottom of the platform 15. In this way, when the container 10 is completely folded it can take up a small amount of storage space in a cabinet.

A plurality of interleaved portions 40 are pivotally attached to the platform 15 and extend circumferentially around the outer diameter edge of the platform 15. In an embodiment, each interleaved portion 40 includes multiple holes 41 formed therein. These holes 41, similar to the apertures 25, allow for steam to penetrate the container 10 during cooking so that the food item placed on the container platform 15 may receive the steam and allow for cooking of the food item. FIGS. 1 and 3 depict the interleaved portions 40 in the opened position. FIG. 4 depicts the interleaved portions 40 in the closed position. The open position is used during cooking to allow for the largest surface area in order to hold the maximum volume of food items. The closed condition of the container 15, with the interleaved portions 40 pivoted toward the center of the platform 15, provides for the easy storage of the container in a smaller space.

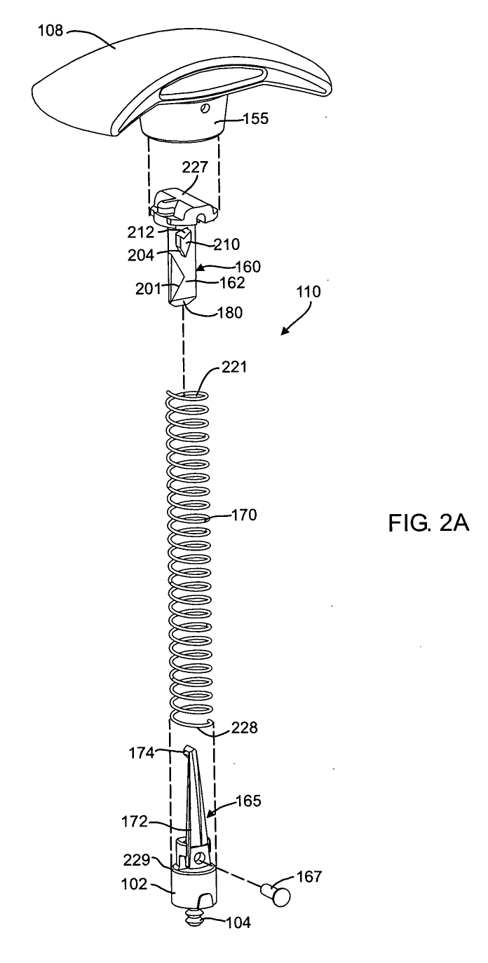

The platform includes a central hub 50. Mounted to the central hub 50 is a handle 100. The handle includes a base 102 that attaches the handle to the platform 15. In an embodiment, the base 102 includes a serrated mounting post 104 which is inserted through an aperture 106 formed in the platform 15. On the handle 100, at the end opposite the base 102, is a grip 108. In an embodiment, the grip 108 includes protruding portions that it may be easily grasped by a user's hand. In an embodiment, the grip 108 also has a curvature in order to correspond to the curvature of most cooking pot lids. The upper portion of the grip 108 is convex in order to correspond to the convex inner surface of a lid of a pot. The grip 108 also includes an aperture 106 for receiving a tool such as a fork to help pull the handle 100 and container 10 out of a steam filled pot. The handle 100 of the present invention includes a latching mechanism 110 (FIG. 2a) that allows for the handle to automatically extend when a lid of a pot is removed from the pot. The handle 100 protrudes above and out of the pot so that the grip 108 may be easily grabbed by a user's hand, without having to reach into the steam filled pot. The latching mechanism 110 also provides for the handle to compress upon placement of a lid on the pot in order to hold the handle 100 down in a semi-compressed condition. The latching mechanism 110 will be described in more detail below.

The latching mechanism 110 is disposed generally in a plurality of telescoping sections 115 as shown in FIG. 2b. The telescoping sections 15 include a first telescoping section 121, second telescoping section 122, and a third telescoping section 123. A first intermediate telescoping section 125 and a second intermediate telescoping section 127 are also provided. Each of the sections 121, 122, 125, 127 include a bottom lip 129a, b, c, d. The first telescoping section 121 includes mounting holes 130a, 130b and cutouts 132a, b.

The second intermediate telescoping section 127 includes a bifurcated gap 134a, b and a cutout 135a, b. The bifurcated gap 134a, b includes at its bottom end a stop abutment 140 and a U-shaped stop 142. The first intermediate telescoping section 125 includes mounting holes 137a, b and shoulders 139a, b.

The second telescoping section 122 includes flanges 144a, b and bifurcated cutouts 146a, b having an abutment 148 at its bottom edge. The second telescoping section 122 also includes a post 150 protruding from each side.

The third telescoping section 123 includes tangs 152a, b. In a preferred embodiment, the telescoping sections 115 are nested in the following manner and as depicted in FIGS. 2b, 3, 4, 6, 7. The third telescoping section 123 is placed inside of the second telescoping section 122 so that the tang 152a, b is inserted within the bifurcated cutout 146a. The tang 152a, b may reciprocate up and down within the bifurcated cutout 146a, b. The second telescoping section 122 is then placed within the first intermediate telescoping section 127 so that the post 150 engages the hole 137a, b, and the second telescoping section 122 is snap-fit within the first intermediate telescoping section 125. The first intermediate telescoping section 125 is then inserted within the second intermediate telescoping section 127, so that each flange 144a, b is received within the corresponding bifurcated gap 134a, b and the flanges 144a, b may reciprocate up and down within the gap 134a, b. When the flange 144a, b rides downward in the bifurcated gap 134a, b, the post 155 is received and abuts against the U-shaped stop 142 and simultaneously the flange 144a, b abuts against a stop abutment 140a, b (FIGS. 2B, 7).

The second intermediate telescoping section 127 is then inserted within the first telescoping section 121. As see in FIGS. 3 and 7, when the telescoping sections 115 are assembled and in the extended condition, the third telescoping section 123 extends downward from the second telescoping section 122, and extends downward and beyond the first telescoping section 121. The first telescoping section 121 is attached to the grip 108 via a pin 154 (FIGS. 4, 6, 7 and 8) that extends through the aperture 130a, b and through the neck 155 of the grip 108 in order to attach the first telescoping section 121 to the grip 108.

The latching mechanism 110 (FIG. 2a) includes a rod 160 having a track 162. The track 162 receives a latching member 165 which is pivotably mounted to the base 102 via a pin 167. A bias member 170, such as a coil spring, extends between the base 120 and the neck 155 of the grip 108. The latching member 165 includes a swing arm 172 and a protruding finger 174. The finger rides in the track 162 in order to lock the handle in the compressed condition, as shown in FIGS. 4 and 6.

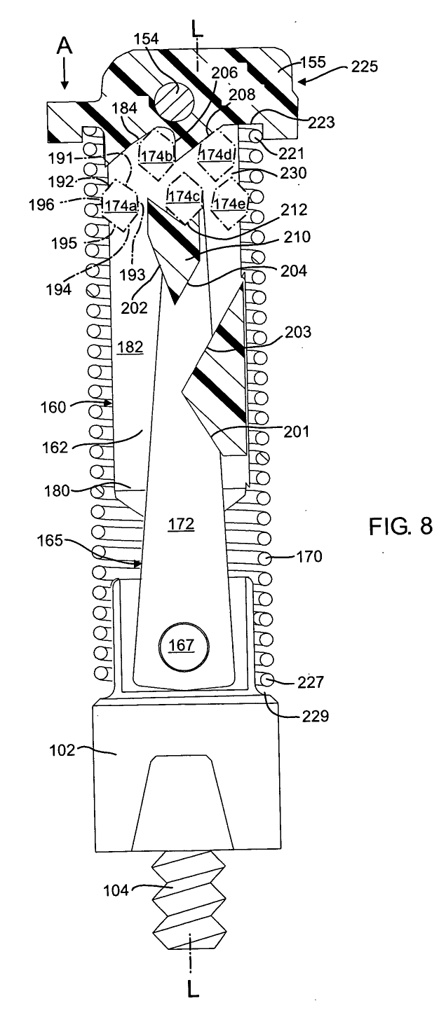

Turning to FIG. 8 the operation of the latching mechanism will be described in greater detail. When the grip 108 is pushed downward in the direction of arrow A (FIG. 8) in order to compress the coil spring 170, the finger 174 of the latching member 165 enters the track 162 at the open end 180 of the track 162. The open end 180 forms the beginning of the compression channel 182. The top of the track 162 includes a lock feature 184. The compression channel 182 extends between the lock feature 184 and the open end 180. The finger 174a is shown (in phantom) in the first position where the finger has moved through the majority of the compression channel 182 and is about to reach the top of the track 162. In an embodiment, the finger 174 is hexagonally shaped in cross section and includes first, second, third, fourth, fifth, and sixth control surfaces 191, 192, 193, 194, 195, 196. Each of the control surfaces 191-196 of the finger 174 acts to engage different positioning features provided by the track 162 in order to control the movement of the latching member 165, so that it follows through the track 162 in a consistent and predictable manner and allows for the handle 100 to move between the compressed and extended conditions. The track 162 includes a first offset feature 201, a second offset feature 202, third offset feature 203 and fourth offset feature 204. The track 162 also includes a vertical feature 206, a release feature 208 and a central feature 210 including a notch 212.

When the finger 174 first enters the track 162 and travels along the compression channel 182, the first control surface 191 abuts against the first offset feature 201 and directs the finger 174 back toward the compression channel 182. As the finger 174 continues to travel upward through the track 162, the first control surface will abut against the second offset feature 202 and force the finger 174 to continue along the compression channel 182 until it is oriented in the position as shown in FIG. 8 (where the finger is marked as 174a). In an embodiment, the finger 174a is in a semi-compressed condition in which the handle 100 is compressed to about 90° of its full compression capacity. Such a semi-compressed condition is sufficient for a lid of a pot (not shown) to seal the top of most standard depth pots. In an embodiment, the spring 170 is chosen so that the weight of a standard lid is sufficient to compress the handle 100 and spring 170 so that the finger 174 reaches the semi-compressed condition 174a. It is understood that the finger 174a is not latched or locked in the track 162 in the semi-compressed condition, but is held in place by the grip 108 and spring 170 pushing against the lid. The handle 100 obtains this semi-compressed condition when the weight of the lid counteracts the bias force of spring 170. Thus, it is understood that so long as the lid is in place, the handle 100 will remain in the semi-compressed condition. Upon removal of the lid, the handle will automatically extend so that the grip protrudes upward and out of the pot. In such a circumstance the finger 174a will reverse its course and move downward through the compression channel 182 (actually a compression/extension channel 182) as the spring 170 biases the rod 160 upward.

In an alternate operation, when the handle 100 is being compressed for storage of the container 10, the finger 174a travels through the compression channel 182 as discussed above. As the grip 108 (and rod 160) continues to be depressed and pushed downward, the finger 174a continues to move upward in the track 162. The second control surface 192 will then come into contact with lock feature 184 which will cause the finger to move into position 174b. This movement will cause the swing arm 172 and finger 174b to pivot toward the longitudinal axis L. The second control surface 192 will ride up the lock feature 184 at the top of the track 162 until the third control surface 193 abuts the vertical feature 206 of the track 162. When the finger 174b is in its uppermost orientation in the track 162 it causes the compression force against the grip 108 to cease. A user who is pushing against the grip 108 will feel the force of the finger 174b abutting the top of the track 162 and being engaged between the lock feature 184 and the vertical feature 206. This abutment of the finger 174b will cause the user to stop pushing down on the grip 108 (or the lid of the pot) and stop the compression force against the handle 100.

As the user reduces the compression force against the grip 108, the coil spring 170 will react with a counterforce pushing the first end 221 of the spring 170 against a first recess 223 of a body 225 of the latching mechanism 110 formed by the head 227 of the rod 160. Opposite the first end 221 of the bias member 170 is a second end 227 which is received in a second recess 229 formed between the base 102 and first telescoping section 121 (FIG. 7). Thus, the compression force of the coil spring 170 pushing against the body 225 at the first recess 223 will cause the rod 160 to move upward and the finger 174b to be moved downward towards the central feature 210. It will move until the finger 174c obtains a latched and locked position where the fourth and fifth control surfaces 194, 195 are abutting against the notch 212.

In an embodiment, the notch 212 of the central feature 210 is generally V-shaped. The fourth and fifth control surfaces 194, 195 also form a corresponding V-shaped latching surface which is retained by the notch 212. As the compression force of the spring 170 continues to push the rod 160 upward, the notch 212 will continue to apply pressure against the latch surface of the finger 174c formed by the fourth and fifth control surfaces 194, 195. Therefore, the combination of the finger 174c abutting against the notch 212 and the compression spring 170 continuing to apply an upward force, causes the handle 100 to obtain a locked and compressed condition (FIGS. 4 and 6). The compressed condition is the orientation that the container 10 will be maintained in during storage. It is to be understood that swing arm 172 is depicted in FIG. 8 in an orientation within the body 225 and track 162 consistent with the locked position when the finger 174c is received in the notch 112. It is to be understood that as the finger 174a, b, d, e travels through the track 162 and is reciprocated in a direction perpendicular to the longitudinal axis L via the track features 184, 201-204, 206 and 208, the swing arm 172 will also reciprocate (although its multiple positions are not shown in FIG. 8).

In an embodiment, after the container 10 is removed from its storage area, the grip is pushed downward slightly and the finger 174c is moved upward (FIG. 8). The second control surface 192 of finger 174d abuts against release feature 208 which causes the swing arm 172 to pivot away from the longitudinal axis so that the finger 174d is located above the extension channel 230. As the finger 174e enters the extension channel 230, the swing arm 172 is pivoted far enough away from the longitudinal axis L, (as the rod 160 moves upward) so that the finger 174e can clear the central feature 210 and that the latch surfaces 194, 195 will not engage the notch 212. Thus, the finger 174 may move past the central feature 210 of the track 162 as the coil spring 170 continues to expand the handle 100.

As the compression spring 170 forces the rod 160 upward, the finger 174e will continue to move downward through the extension channel 230, until the fourth control surface 194 engages the third offset feature 203. The third offset feature 203 will cause the swing arm 172 to pivot back toward the longitudinal axis L of the track 162 (FIG. 8) and the second control surface 192 of the finger 174e will then abut against the fourth offset feature of the track 162. This pivoting will allow the finger 174e to move downward through the track 162 and move towards the open end 180 of the track 162. As the compression spring 170 continues to apply a force against the body 225, the finger 174 will be extended beyond the open end 180 of the track 162 and the rod 160.

As the compression spring 170 continues to push the body 225 and the rod 160 upward, the telescoping sections 121, 122, 123 will move apart and will extend and elongate to achieve the extended condition, as shown in FIGS. 1, 3 and 7. The compression spring 170 causes the first telescoping section 121 and grip 108 to travel upward and the second telescoping section 122, intermediate telescoping sections 125, 127 and third telescoping section 123 to extend downward. A majority of the second and intermediate sections 122, 125 extend from the bottom lip 129a of the first section 121 until the flanges 144a, b abut against the stop abutment 140a, b (FIGS. 2B and 7). Simultaneously, the third telescoping section 123 will extend outward beyond the bottom lip 129b of the intermediate telescoping section 125 until the tangs 152a, b engage the abutment 148 of the second telescoping section 122.

Although the preferred embodiment depicts generally three telescoping sections and intermediate sections, it is understood that the present invention could have as few as two telescoping sections. In another embodiment, the handle may have many more telescoping sections than depicted, in order to provide a handle that extends even further. The arrangement depicted includes the latching member 165 disposed inside of the coil spring 170 and the latching member 165 positioned along side the bias member 170 during its compression and expansion. However, other arrangements may be possible. For example, a pair of bias members may be provided on alternate sides of the latching member 165. As well, multiple latching members may be provided. In an alternate embodiment, the finger 174 may be provided by the rod 160 or handle and a track and notch provided as part of the base 102.

Therefore, it is understood that the present invention provides for a method of controlling compression and extension of the handle 100 by following steps of compressing the handle 100 with a first actuation force in direction of arrow A (FIG. 8). The latching member 165 is then advanced through the track 162 and causes the second telescoping section 122 to nest at least partially within the first telescoping section 121. The compression of the handle will cause the latching member 165 to lock within the track 162 to provide a locked position. The handle 100 is in a compressed condition, as shown in FIGS. 4 and 6. Compressing the handle 100 with a second actuation force in the direction of arrow A (FIG. 8), causes the latch member 165 to be released from the locked position 174c. In particular, the latch finger 174c is released from the notch 212 of the track 162. The latching member 165 may then advance through the track 162 so that the handle 100 extends as a result of the telescoping sections 121, 122, 123 separating. The first telescoping section 121 and the latching member 165 will extend beyond the track 162. In particular, the finger 174 will exit the open end 180 of the track 162 and the finger 174 will move downward so that it is extended beyond the bottom lip 129a of the first telescoping section 121.

It is also to be understood that the offset features 201-204 and other features 184, 206, 208, of the track 162 cause the latching member 165 to reciprocate within the track 162. These features move the finger 174 of the latching member 165 in and out of the locked position 174c. The track control features 184, 201-204, 206, 208 reciprocate the latching member 165 in a direction that is perpendicular to the longitudinal axis L of the track 162. When the finger 174 advances through the compression channel 182, the handle is compressed. When the finger 174 extends through the extension channel 230, the handle 100 will be extended. When the handle 100 is in the extended condition, a majority of the second telescoping section 122 is extended at least partially beyond the exposed end 129a of the first telescoping section 121. The third telescoping section 123 is then extended at least partially beyond the exposed end 129b of the second telescoping section 122 and the exposed end 129c of the intermediate section 125. The uncovered end 129b of the second telescoping section protrudes beyond the open end 129a of the first telescoping section 121 and the third telescoping section 123 extends beyond the uncovered end 129b of the second telescoping section 122.

Due to the orientation of the control features 184, 201-204, 206, 208 within the track 162, it is understood that upon application of the second compression force, the handle 100 automatically extends to the extended condition. Due to the releasing of the finger 174c from the notch 212 and the reciprocating movement of the swing arm 172, the finger 174 may be moved automatically out of the track 162 of the rod 160. It is to be understood that the swing arm 172 of the latching member 165 is freely pivotable within the track 162. The finger 174 is only controlled within the track 162 by the offset features 184, 201-204, 206, 208 of the track. In an alternate embodiment, a finger 174 may be located on a slide mechanism mounted to one of the telescoping sections 121-123. It is also to be understood that the present invention may provide an indexing apparatus, where the finger 174 locks in the locked position in the notch 212 in order to index the handle at a first position. It is to be understood that in an alternate embodiment, the track may be altered to include additional notches and other features in order to allow the handle 100 to be indexed in additional positions, such as depicted in co-pending application Ser. No. 11/128,833 which is incorporated herein by reference. Such additional features may provide for additional locked positions where stepped and gradual extension of the handle 100 is desired. It is also understood that while the preferred embodiment discloses a finger 174 having a hexagonally shaped cross section, many other shaped fingers may be provided such as diamond shaped or other polygonal and non-polygonal shaped fingers. In addition, it is understood that it is not required for the finger to have each of the first, second, third, and fourth control surfaces 191-194 and may have other surfaces and shapes.

The matter set forth in the foregoing description and accompanying descriptions is offered by way of illustration only and not as a limitation. While particular embodiments have been shown and described, it will be obvious to those skilled in the art that changes and modifications may be made without departing from the broad aspects of applicant's contribution. The actual scope of the protection sought is intended to be defined in the following claims when viewed in their perspective when based on the prior art.

1. A container comprising:
a platform supported by legs; and
a handle extending from the platform and including a base for attaching the handle to the platform, a first telescoping section attached to the base and nested within a second telescoping section, a grip attached to the second telescoping section, a rod extending from the grip and a latching member attached to the base for engaging the rod when the handle is in a compressed condition.

2. The container of claim 1 wherein the legs are pivotally attached to the platform.

3. The container of claim 1 wherein each leg is formed of wire having a generally rectangular shape having a first side and a second side, the first side received by a generally U-shaped bracket attached to the platform and the second side of the leg is bent to provide a support foot.

4. The container of claim 1 wherein the platform is formed of interleaved portions pivotally attached to a central hub and each section moveable between an open and a closed position.

5. The container of claim 1 wherein the rod includes a track for receiving the latching member and the track having a compression channel through which the latching member advances during compression of the handle and an extension channel through which the latching member advances during extension of the handle.

6. The container of claim 5 wherein the latching member includes a finger that rides upward through the compression channel to at least a semi-compressed condition and downward through the extension channel or the compression channel.

7. The container of claim 1 wherein the handle is biased in order to extend the handle when the latching member is released from the rod.

8. The container of claim 7 wherein the container is disposed in an enclosure having a lid and the handle abutting the lid when the handle is in the compressed condition and removal of the lid allows the latching member to ride upward through the compression channel and allow the handle to extend out of the enclosure.

9. A telescoping handle comprising:
a first and second telescoping section;
a base attached to the first telescoping section and a latching member pivotally attached to the base;
a rod having a track and the second telescoping section surrounding the rod;
the handle having a compressed condition and an extended condition and the latching member received in the track and engaging the rod in the compressed condition; and
the latching member disposed from the track in the extended condition.

10. The handle of claim 9 wherein the latching member includes a finger that rides in the track and engages a notch formed within the track so that the handle is locked in the compressed condition.

11. The handle of claim 10 wherein the handle includes a bias member for biasing the handle to the extended condition when the finger is released from the notch.

12. The handle of claim 10 wherein the track includes a release feature that directs the finger away from the notch toward an extension channel so that the handle is provided in the extended condition.

13. The handle of claim 12 wherein the track comprises a longitudinal axis and pressing on the handle imparts a compression force along the longitudinal axis and the compression force causes the finger to engage the release feature so that the handle is biased to the extended condition.

14. The handle of claim 10 wherein the track includes a lock feature that directs the finger toward the notch so that the finger engages the notch in order to lock the handle in the compressed condition.

15. The handle of claim 10 wherein the finger has a first control surface and a second control surface and the track having a compression channel, an extension channel, a release feature and a first off-set feature so that upon moving the finger through the track the first control surface engages the first off-set feature to move the finger into the compression channel and the second control surface engages the release feature to move the finger into the extension channel.

16. The handle of claim 10 wherein the finger includes a latch surface for engaging the notch of the track after the finger is directed by a lock feature of the track.

17. The handle of claim 16 wherein a generally V-shaped notch is formed in the track and the latch surface is generally V-shaped to engage the notch in order to lock the handle in the compressed condition.

18. A method for controlling compression and extension of a handle comprising the steps of:
providing a handle including a first and second telescoping section, a base, a latching member attached to the base and a track disposed within the first telescoping section;
compressing the handle with a first actuation force;
advancing the latching member through the track and nesting the first telescoping section at least partially within the second telescoping section;
locking the latching member within the track in a locked position to lock the handle in a compressed condition;
compressing the handle with a second actuation force;
releasing the latching member from the locked position; and
advancing the latching member through the track so that the base is extended beyond the second telescoping section and the latching member is extended beyond the track.

19. The method of claim 18 wherein the track includes off-set features to cause the latching member to reciprocate within the track in order to move in and out of the locked position.

20. The method of claim 18 wherein the track includes a longitudinal axis and the latching member reciprocates perpendicular to the longitudinal axis.

21. The method of claim 18 wherein the track includes an extension channel and a compression channel and the method further comprising the steps of:
advancing the latching member through the extension channel causing the handle to extend; and
advancing the latching member through the compression channel causing the handle to compress.

22. The method of claim 18 wherein the first telescoping section includes a nested end and an opposite uncovered end and the second telescoping section includes a grip end and an opposite exposed end and the latching member is extended beyond the exposed end of the second telescoping section when the handle is in an extended condition and a majority of the first telescoping section is extended at least partially beyond the exposed end of the second telescoping section.

23. The method of claim 22 wherein the handle includes a third telescoping section having a covered end nested with the uncovered end of the second telescoping section and a base having the latching member and in the extended condition the base extends beyond the uncovered end.

24. The method of claim 18 further providing a profiled notch in the track corresponding to the shape of the latching member and the track including a release feature and the method further comprising the step of:
automatically advancing the latching member from the locked position to an unlocked and extended condition of the handle due to the latching member being directed out of the profiled notch toward the release feature that advances the latching member to the extension channel.

25. The method of claim 18 further providing a first off-set feature and a lock feature in the track, the method further comprising the step of:
automatically advancing the latching member from the unlocked position to the locked position due to the latching member being directed by the first off-set feature into the compression channel that advances the latching finger against the lock feature and into the notch in order to obtain the locked position.

26. The method of claim 18 wherein the latching member is freely pivotable between a locked and unlocked position and is advanced only by off-set features provided by the track.

27. The method of claim 18 wherein the handle includes only one bias member acting to bias the first telescoping section away from the second telescoping section.

28. A latching mechanism comprising:
a body including a stop abutment and a track having a first off-set feature and a notch;
a latching member extending from a base, the latching member including a first control surface and a latch surface;
the latching member rides in the track between a locked position and an unlocked position and the first control surface engages the first off-set feature directing the latch surface to engage the notch to obtain the locked position; and
a bias member biasing the latching member and body apart until the stop abutment is engaged and the latching member is in the unlocked position.

29. The latching mechanism of claim 28 wherein the body includes a first recess for receiving a first end of the bias member and the first recess generally adjacent the notch, the body also includes a second recess for receiving a second end of the bias member and the second recess generally adjacent the base so that the latching member is positioned along side the bias member during its compression and expansion.

30. The latching mechanism of claim 28 wherein the track is formed in a rod attached to a telescoping section and the bias member at least partially surrounds the rod.

31. The latching mechanism of claim 28 wherein the body further comprising a first telescoping section and a second telescoping section and the stop abutment disposed on the first telescoping section and a flange protruding from the second telescoping section and wherein the bias member extends between the track and the base and the bias member biasing the track upward away from the latching member until the flange engages the stop abutment.

32. An indexing apparatus comprising:
a rod having a guide track;
a finger disposed in the track and the finger having a first control surface and a second control surface;
a bias member causing the finger to travel and reciprocate within the track and travel to an extended position beyond the track; and
positioning features working in combination with the finger and the bias member and engaging the first and second control surfaces in order to control the position of the finger and lock the finger in a locked position.

33. The apparatus of claim 32 wherein the rod extends from a grip and the indexing apparatus provides a locking mechanism for a handle.

34. The apparatus of claim 32 wherein the finger protrudes from a latching member pivotally mounted to a base disposed adjacent the track.

35. The apparatus of claim 32 wherein the finger has a generally hexagonally shaped cross-section.

36. The apparatus of claim 32 wherein the bias member causes the finger to reciprocate along a longitudinal axis of the track.

37. The apparatus of claim 32 wherein the position features include an off-set feature and a lock feature provided by an inner wall of the track in order to cause the finger to reciprocate within the track generally perpendicular to a longitudinal axis of the track.

38. The apparatus of claim 32 wherein the track includes a compression channel and an extension channel and the finger traveling in the compression channel to move the finger away from the extended position and in the extension channel to move the finger toward the extended position.
